(19) United States
(12) Patent Application Publication
(10) Pub. No.: US 2012/0019364 A1
(43) Pub. Date: Jan. 26, 2012

(54) RFID READING APPARATUS

(75) Inventors: Jürgen REICHENBACH, Emmendingen (DE); Andreas GÜNTHER, Bargteheide (DE)

(73) Assignee: SICK AG, Waldkirch (DE)

(21) Appl. No.: 13/188,490

(22) Filed: Jul. 22, 2011

(30) Foreign Application Priority Data
Jul. 26, 2010 (DE) 20 2010 008 162.9

(51) Int. Cl. H04Q 5/22

(52) U.S. Cl. 340/10.1

(57) ABSTRACT

An RFID reading apparatus (10) is provided for stationary mounting at a reading zone (18) of a conveyor (12) or of a reading portal (40) for reading out at least one RFID transponder (22) moved on the conveyor (12) or through the reading portal (40), having a receiver (32) and a plurality of antennas (24, 26) connected to the receiver (32) for receiving RFID signals from the RFID transponder (22) as well as having an evaluation unit (36) for reading out RFID information from the received RFID signals, wherein the RFID reading apparatus (10) includes a first housing (28) in which the receiver (32) and the evaluation unit (36) are accommodated. In this respect, one of the antennas is an internal antenna (24) which is mechanically fastened to the first housing (28) and another of the antennas (28) is an external antenna.

The invention relates to an RFID reading apparatus for stationary mounting at a reading zone of a conveyor or of a reading portal.

RFID reading systems serve for the identification of objects and products and are used inter alia to automate logistical movements. RFID transponders fastened to the products are read out at an identification point, above all on a change of the owner of the product or on a change of the transport means, and information is optionally written back into the transponder. This results in fast and understandable logistical movements. The detected information is used to control the forwarding and sorting of goods and products. Important applications for automatic identification are logistical distribution centers, for instance of package shippers, or the baggage check-in at airports.

Such transponders can basically be active, that is have their own energy supply and generate electromagnetic radiation independently. In practice, however, these transponders are less suitable for logistics because the unit prices for such transponders cannot reach the low level required for the mass market due to the energy supply. Passive transponders without their own energy supply are therefore usually used. In both cases, the transponder is excited to radiate the stored information by electromagnetic radiation of the reading device, with passive transponders taking the required energy from the transmission energy of the reading system. In the established ultra high frequency standard ISO 18000-6, passive transponders are read out using the backscatter process.

A frequency deployment site of RFID reading systems is the assembly at a conveyor belt on which the goods are conveyed or in a so-called reading portal. Any desired passageway is to be understood by this which is equipped with one or more RFID readers and possibly with further sensors. Objects are moved through the reading portal by means of a conveyor belt, by means of a transport vehicle such as a forklift, or also manually and are in so doing identified with respect to their RFID transponder.

Reading portals are frequently set up with a plurality of antennas to achieve a good field strength coverage in the passage zone despite bodies which are difficult to pass through an despite reflections from all directions. For this purpose, a plurality of antennas are connected externally to the RFID reading system and are addressed via multiplexers. Such a system is, for example, known from US 2008/0129512 A1. In this respect, however, a great effort and/or cost arises for the assembly and wiring of the external antennas.

US 20060221363 A1 shows a handheld portable printer with an RFID read/write module. An internal antenna and an external antenna are provided at its housing to be able to carry out RFID writing operations to internal and external transponders. This construction, however, does not solve the problem of the complete coverage of a reading zone because the external antenna is connected to the printer and the internal antenna is not suitable at all for external RFID operations.

It is therefore the object of the invention to set forth an RFID reading apparatus which achieves a good coverage of a reading zone with a small apparatus effort and a small assembly effort.

This object is satisfied by an RFID reading apparatus set forth in claim 1 for stationary assembly at a reading zone of a conveyor or of a reading portal for reading out at least one RFID transponder moved on the conveyor or through the reading portal.

The solution starts from the basic idea of using a plurality of antennas for the better coverage of the reading zone. In this respect, one of the antennas is designed as an internal antenna which is fastened to the housing of the actual RFID reading apparatus, that is the electronics for transmitting, receiving and evaluating RFID signals. In addition, one or more external antennas are not mechanically connected to this housing, but are rather only electronically connected to the receiver via a connection line and are mounted at a different location.

The invention has the advantage that wiring connections, assembly effort and installation effort are avoided. The integrated antenna does not have to be separately connected and assembled. In addition, a separate housing for the integrated antenna is saved.

The internal antenna is preferably integrated into the first housing. The first housing thus ultimately acquires the required antenna properties. This results in a particularly compact and easy-to-handle construction.

The internal antenna is preferably a patch antenna. The antenna can thus be integrated particularly simply into a housing wall or a circuit board of the electronics of the RFID reading apparatus.

The internal antenna and the external antenna are preferably of the same construction as one another. Only one type of antenna thus has to be planned and integrated. The antennas behave the same from the aspect of the electronics of the RFID reading apparatus. If the antennas are not of the same construction, it is advantageous if they are at least so similar to one another that similar electronic controls are possible and the same signals are produced.

The external antenna is preferably integrated into a second housing which is of the same construction as the first housing. The external antenna thus corresponds to the actual RFID reading apparatus in the first housing, but is liberated of all inner electronics such as a receiver, transmitter, multiplexer or evaluation unit. Cost advantages arise due to the multiple use of the same mechanical platform for the internal and external antennas due to volume effects.

The RFID reading apparatus preferably has a transmitter which is connected to the antennas to transmit a carrier signal and/or an RFID signal. The carrier signal supplies the RFID transponder, as mentioned in the introduction, with the required energy. The communication with RFID transponders becomes bidirectional by transmission of RFID signals; that is writing processes are also supported in addition to reading processes.

The RFID reading apparatus preferably has a multiplex unit to connect the receiver and/or the transmitter selectively to one of the antennas. One receiver and one transmitter are sufficient thanks to multiplexing, for example time multiplexing in time slots, with a switchover taking place between the antennas.

In an advantageous further development of the invention, a reading tunnel is provided having at least one RFID reading apparatus in accordance with the invention mounted at the reading tunnel, with an electromagnetic shielding unit protecting the reading zone from electromagnetic interference radiation. The electromagnetic shielding on the one hand ensures that the RFID reading apparatus only receives signals of the associated reading zone where possible. On the other hand, interference radiation is outwardly shielded, for example in order not to interfere with adjacent further RFID reading gates. A reading tunnel usually holds the RFID reading apparatus as well as the external antennas and can be designed as a tube or as a box at whose narrow sides the RFID transponders move in and out.

The first housing is advantageously mounted on the one side and an external antenna on the opposite side of the reading tunnel. The reading zone is thus well covered by only two antennas, that is an internal antenna and an external antenna. Alternatively, further antennas are also conceivable, for instance a respective antenna from above, from below, from the right sand from the left, with the internal antenna adopting the role of any one of these antennas.

The invention will be explained in more detail in the following also with respect to further features and advantages by way of example with reference to embodiments and to the enclosed drawing. The Figures of the drawing show in:

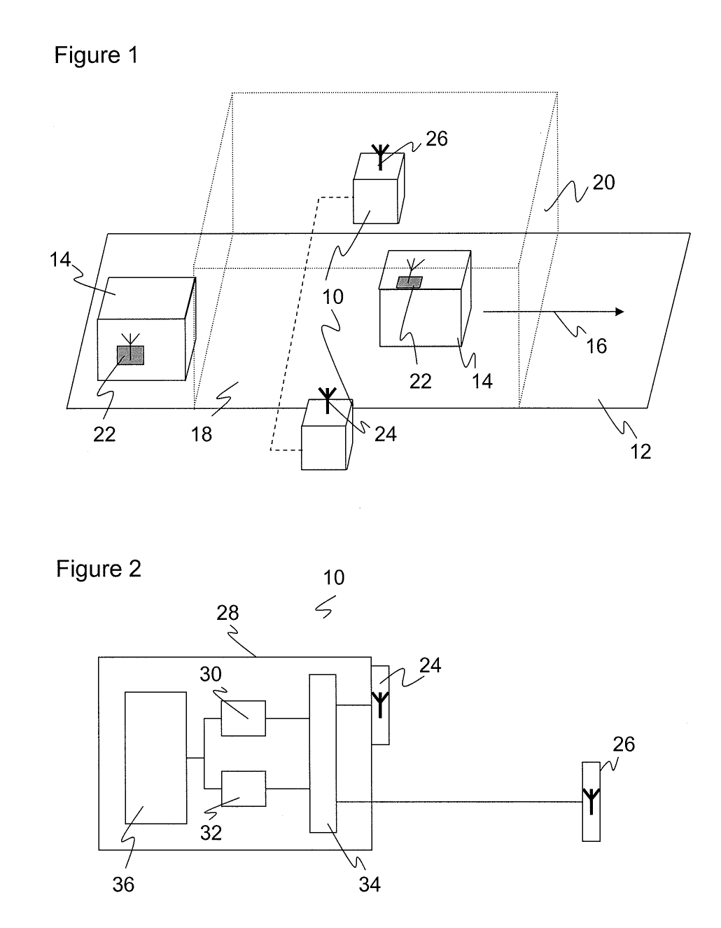

FIG. 1 a schematic three-dimensional overview representation of an RFID reader in accordance with the invention at a conveyor belt;

FIG. 2 a block diagram of the RFID reader in accordance with FIG. 1;

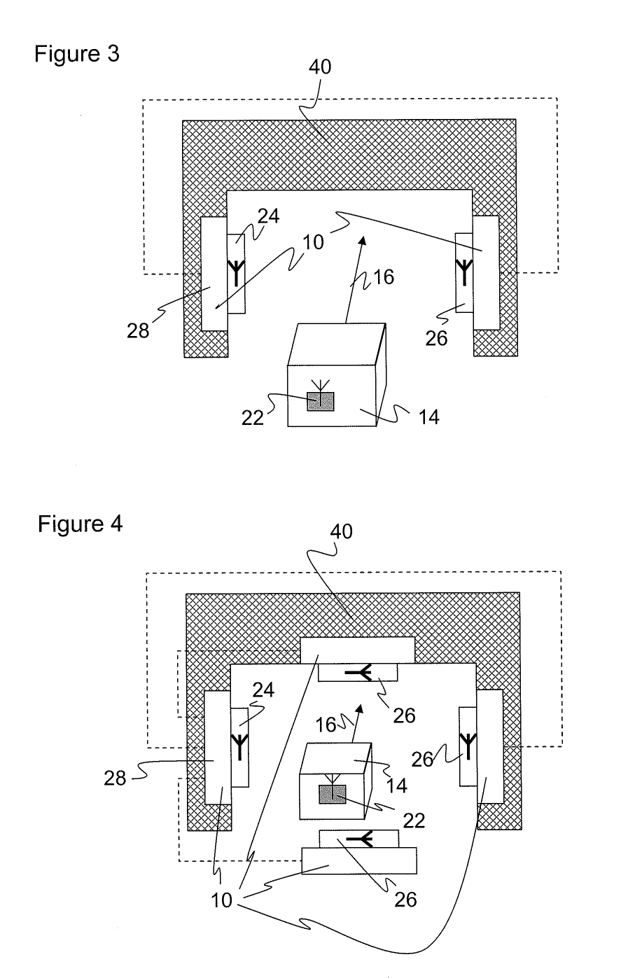

FIG. 3 a schematic representation of a reading gate with an RFID reader in a first embodiment having one internal antenna and one external antenna; and

FIG. 4 a schematic representation of a reading gate with an RFID reader in a second embodiment having one internal antenna and three external antennas.

FIG. 1 shows an overview representation of an RFID reader 10 in accordance with the invention which is mounted at a conveyor 123 which conveys objects 14 in a direction marked by an arrow 16 through a reading zone 18. An electromagnetic shield 20, only shown schematically, is provided above the reading zone 18. Differing from the representation, the reading tunnel thus created can include further RFID readers or further antennas to detect RFID signals at further positions and from further directions. Equally, other sensors are possibly provided to acquire additional information on the objects 14, for example their entry into and exit from the reading zone or the volume or weight of the objects 14. Finally, the invention also includes reading portals at which no automatic conveyor 12 is provided, but rather in which vehicles or persons which/who can carry the objects 14 with them move through the reading portal

RFID transponders 22 are arranged at the objects 14 and are read out by the RFID reader 10 when they are located in the reading zone 18. For this purpose, the RFID reader 10 has an integrated antenna 24 and an external antenna 26 for transmitting and/or receiving RFID signals.

FIG. 2 shows the RFID reader again in a block diagram. Here and in the following, the same reference numerals designate the same or mutually corresponding features. The evaluation and control electronics are located in a housing to encode RFID information into an RFID signal and to transmit it or to receive an RFID signal and to read out a piece of information from it.

For this purpose, a transmitter 30 and a receiver 32 are connected to a multiplexer 34 via which selectively the internal antenna 24 or the external antenna 26 is addressed by a multiplex process. In this respect, time multiplexing is preferably used to control the internal antenna 24 and one or more external antennas 265 offset in time. A control and evaluation unit 36 receives an electronic signal corresponding to the received RFID signals from the receiver 32 or, via the transmitter 30, causes an RFID signal to be radiated. The evaluation unit 36 knows the RFID protocols to be used to encode information into an RFID signal or to read out an RFID signal. RFID communication per se is known. The required components of the evaluation unit 36 and the steps required for RFID communication will therefore not be looked at in more detail.

The internal antenna 24 is fastened to the housing 28 and is preferably integrated as a patch antenna into the housing wall or into circuit boards of the evaluation and control electronics. It is also conceivable to provide a plurality of internal antennas 24, but due to their spatial proximity this is usually less advantageous than the use of additional external antennas 26.

The external antenna 26 is in a special embodiment of the same construction as the housing 28 and the internal antenna 24. In other words, the external antenna 26 arises by omitting the evaluation and control electronics from a housing corresponding to the housing 28. An RFID reading apparatus with an internal antenna 24 or an external antenna can thus selectively be manufactured inexpensively from the same basic module, namely the mutually identical housings 28.

FIG. 3 shows the mounting of the RFID reading apparatus 10 at a reading gate 40. The configuration can fully correspondingly also be used at a conveyor 12; the reading zone 18 can there also be understood as a reading gate 40. The reading gate 40 holds the housing 28 with the internal antenna 24 on the one side and the external antenna 26 connected thereto on the other side. The objects 14 to be detected move through the reading gate 40, that is into the plane of the paper, in this representation. The reading gate 40 is provided with an electromagnetic shield so that the electromagnetic fields of the RFID communication within the reading gate 40 do not enter into interaction with the external zone of the reading gate 40. A housing and wiring are saved with respect to a conventional solution having a plurality of external antennas by use of the internal antenna 24.

Although the reading gate can frequently be covered very well by two antennas, additional external antennas 26 can also be used. FIG. 4 shows a representation similar to FIG. 3 in which three external antennas 26 are used, for example, to realize a reading from the right, the left, from above and from below. Interference due to shadowing effects and multiple reflections are thus avoided.

1. An RFID reading apparatus (10) for stationary mounting at a reading zone (18) of a conveyor (12) or of a reading portal (40) for reading out at least one RFID transponder (22) moved on the conveyor (12) or through the reading portal (40), having a receiver (32) and a plurality of antennas (24, 26) connected to the receiver (32) for receiving RFID signals from the RFID transponder (22) as well as having an evaluation unit (36) for reading out RFID information from the received RFID signals, wherein the RFID reading apparatus (10) includes a first housing (28) in which the receiver (32) and the evaluation unit (36) are accommodated, wherein one of the antennas is an internal antenna (24) which is mechanically fastened to the first housing (28); and wherein another of the antennas (28) is an external antenna.

2. An RFID reading apparatus (10) in accordance with claim 1, wherein the internal antenna (24) is integrated into the first housing (28).

3. An RFID reading apparatus (10) in accordance with claim 1, wherein the internal antenna (24) is a patch antenna.

4. An RFID reading apparatus (10) in accordance with claim 1, wherein the internal antenna (24) and the external antenna (26) are of the same construction as one another.

5. An RFID reading apparatus (10) in accordance with claim 1, wherein the external antenna (26) is integrated into a second housing which is of the same construction as the first housing (28).

6. An RFID reading apparatus (10) in accordance with claim 1, which has a transmitter (30) which is connected to the antennas (24, 26) to transmit a carrier signal and/or an RFID signal.

7. An RFID reading apparatus (10) in accordance with claim 1, which has a multiplex unit (34) to connect the receiver (32) and/or the transmitter (30) selectively to one of the antennas (24, 26).

8. A reading tunnel (40) having at least one RFID reading apparatus (10) mounted at the reading tunnel (40), said RFID reading apparatus being designed for stationary mounting at a reading zone (18) of a conveyor (12) or of a reading portal (40) for reading out at least one RFID transponder (22) moved on the conveyor (12) or through the reading portal (40), having a receiver (32) and a plurality of antennas (24, 26) connected to the receiver (32) for receiving RFID signals from the RFID transponder (22) as well as having an evaluation unit (36) for reading out RFID information from the received RFID signals, wherein the RFID reading apparatus (10) includes a first housing (28) in which the receiver (32) and the evaluation unit (36) are accommodated, wherein one of the antennas is an internal antenna (24) which is mechanically fastened to the first housing (28); and wherein another of the antennas (28) is an external antenna, wherein an electromagnetic shielding unit (20) protects the reading zone (18) from electromagnetic interference radiation.

9. A reading tunnel (40) in accordance with claim 9, wherein the first housing (28) is mounted on the one side and an external antenna (26) is mounted on an opposite side of the reading tunnel (40).
